(19) United States
(12) Patent Application Publication
(10) Pub. No.: US 2026/0330991 A1
(43) Pub. Date: Oct. 22, 2026

(54) METHOD OF GENERATING STUDENT-TAILORED EDUCATION FEEDBACK AND INFORMATION EXTRACTION METHOD FOR THE SAME

(71) Applicant: ELECTRONICS AND TELECOMMUNICATIONS RESEARCH INSTITUTE, Daejeon (KR)

(72) Inventor: Wencke Liermann, Daejeon (KR)

(21) Appl. No.: 19/355,504

(22) Filed: Oct. 10, 2025

(30) Foreign Application Priority Data
Apr. 18, 2025 (KR) 10-2025-0051109

(51) Int. Cl. G09B 7/04; G06F 40/284; G06F 40/35

(52) U.S. Cl. CPC G09B 7/04; G06F 40/284; G06F 40/35

(57) ABSTRACT

Provided are a method of generating student-tailored education feedback and a method of extracting information for the same. The method of generating student-tailored education feedback may include an information extraction step of extracting required learning material information from a learning material and a feedback generation step of generating personalized feedback based on the extracted learning material information, a question to contents, and an incorrect answer of a student. The information extraction step may be performed by using a dialogue model that is trained by using a first model input including paragraphs, questions, and answers and a second model input that is extended from the first model input and that comprises paragraphs, key sentences, questions, and answers.

### CROSS-REFERENCE TO RELATED APPLICATION

The present application claims priority to and the benefit of Korean Patent Application No. 10-2025-0051109, filed on Apr. 18, 2025, in the Korean Intellectual Property Office, the entire disclosure of which is incorporated herein by reference.

### BACKGROUND

### 1. Technical Field

The present disclosure relates to a method of generating student-tailored education feedback and a method of extracting information for the same.

### 2. Description of Related Art

An automated tutoring system is used in the education of students. In order to achieve educational objectives, such a system is required to identify and correct an error in contents that are understood by a student like an actual teacher, rather than merely transferring knowledge.

A knowledge-grounded dialogue technique and a student error analysis technique are necessary to generate such student-tailored feedback.

The knowledge-grounded dialogue technique is a deep learning-based dialogue technique that selects useful information in dialogues with a user by using given text data, an external knowledge graph, or a pre-defined knowledge base and that generates a response based on the useful information. In common fields, information directly related to the topic of a dialogue needs to be basically extracted. In contrast, in the education field, indirect information that is useful in solving a problem, in addition to information directly related to an answer to an educational question, also needs to be identified and selected. The existing knowledge-grounded dialogue technique has limits in generating such an indirect hint.

The student error analysis technique plays an important role in diagnosing an error occurring in the learning process of a student, identifying a learner's current understanding, and providing tailored support capable of maximizing learning effects based on the learner's current understanding. However, many feedback techniques provide a student with the same feedback or an answer instead of feedback by using a pre-defined feedback template. This does not show the potential of feedback.

### SUMMARY

Various embodiments are directed to providing a high-performance feedback generation technique for effectively processing an incorrect answer of a student in an automated education system.

A method of generating student-tailored education feedback according to an embodiment of the present disclosure includes an information extraction step of extracting required learning material information from a learning material and a feedback generation step of generating personalized feedback based on the extracted learning material information, a question to contents, and an incorrect answer of a student.

In an embodiment, the learning material information may include one or more key sentences of the learning material.

In an embodiment, the information extraction step is performed by using a dialogue model that is trained by using a first model input including paragraphs, questions, and answers and a second model input that is extended from the first model input and that comprises paragraphs, key sentences, questions, and answers.

In an embodiment, the dialogue model is trained by using a negative log-likelihood (NLL) loss of the first model input and the second model input as a first loss function.

In an embodiment, the first loss function may further include a Kullback-Leibler (KL) regularization term between a distribution generated by the first model input and an output distribution generated by the second model input.

In an embodiment, the feedback generation step includes filtering information based on the question and the incorrect answer among pieces of key information extracted in the information extraction step and generating the personalized feedback based on the filtered information.

In an embodiment, the feedback generation step is performed by using the dialogue model trained by using a second loss function that is generated by generating a plurality of feedback candidates, calculating an entailment probability of each of the feedback candidates, selecting feedback having a highest entailment probability and feedback having a lowest entailment probability, among the plurality of feedback candidates, as a preferred response and a non-preferred response, respectively, and increasing a relative log probability of the preferred response to the non-preferred response by using direct preference optimization (DPO).

In an embodiment, the plurality of feedback candidates may be generated by using a top-K sampling scheme.

In an embodiment, the second loss function may include a loss function generated by using the first model input and a loss function generated by using the second model input.

In an embodiment, the second loss function may further include a KL regularization term between the distribution generated by the first model input and the output distribution generated by the second model input.

An information extraction method of generating student-tailored education feedback according to an embodiment of the present disclosure includes extracting required learning material information from a learning material by using a dialogue model that is trained by using a first model input including paragraphs, questions, and answers and a second model input that is extended from the first model input and that comprises paragraphs, key sentences, questions, and answers.

In an embodiment, the learning material information may include one or more key sentences of the learning material.

In an embodiment, the dialogue model may be trained by using a negative log-likelihood (NLL) loss of the first model input and the second model input as a first loss function.

In an embodiment, the first loss function may further include a Kullback-Leibler (KL) regularization term between a distribution generated by the first model input and an output distribution generated by the second model input.

The information extraction method of generating student-tailored education feedback according to an embodiment may further include tokenizing the first model input and the second model input by using an encoder-decoder pair.

A method of generating student-tailored education feedback according to an embodiment of the present disclosure generates personalized feedback based on learning material information, a question to contents, and an incorrect answer of a student. The generation of the personalized feedback is performed by using a dialogue model trained by using a second loss function that is generated by generating a plurality of feedback candidates, calculating an entailment probability of each of the feedback candidates, selecting feedback having a highest entailment probability and feedback having a lowest entailment probability, among the plurality of feedback candidates, as a preferred response and a non-preferred response, respectively, and increasing a relative log probability of the preferred response to the non-preferred response by using direct preference optimization (DPO).

In an embodiment, the plurality of feedback candidates may be generated by using a top-K sampling scheme.

In an embodiment, the second loss function includes a loss function generated by using the first model input and a loss function generated by using the second model input.

In an embodiment, the second loss function further includes a KL regularization term between the distribution generated by the first model input and the output distribution generated by the second model input.

The method of generating student-tailored education feedback according to an embodiment of the present disclosure may further include tokenizing the first model input and the second model input by using an encoder-decoder pair.

According to an embodiment of the present disclosure, the accuracy of feedback and learning material fidelity are improved, and education efficiency can be maximized because information to be provided is selected based on student understanding that is expressed as an incorrect answer of a student.

Effects of the present disclosure are not limited to the aforementioned effects, and other effects not described above may be evidently understood by those skilled in the art from the following description.

### BRIEF DESCRIPTION OF THE DRAWINGS

FIG. 1 is a block diagram illustrating a construction of an apparatus for generating student-tailored education feedback according to an embodiment of the present disclosure.

FIG. 2 is a flowchart illustrating an operation of generating personalized feedback according to an embodiment of the present disclosure.

FIG. 3 is an explanatory diagram illustrating an operation of generating personalized feedback in an embodiment of the present disclosure.

FIG. 4 is an explanatory diagram for describing a training process of the apparatus for generating student-tailored education feedback according to an embodiment of the present disclosure.

FIG. 5 illustrates sentences having meanings related to key sentences in the example sentence of FIG. 3.

FIG. 6 is an explanatory diagram for describing a method of selecting one of a plurality of feedback candidates.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

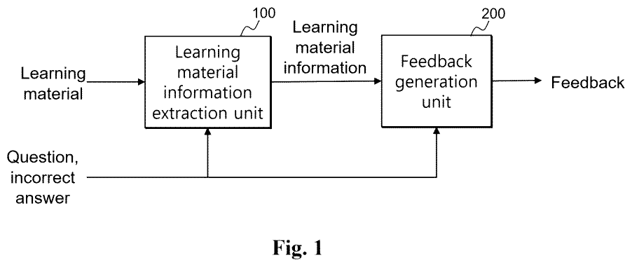

An apparatus for generating student-tailored education feedback according to an embodiment of the present disclosure generates personalized feedback when a learning material, a question to learning material contents, and an incorrect answer of a student for a question are given. FIG. 1 is a block diagram illustrating a construction of an apparatus for generating student-tailored education feedback according to an embodiment of the present disclosure. A learning material information extraction unit 100 extracts learning material information from a learning material. The learning material information extraction unit 100 extracts key sentences because a specific portion rather than the entire text, that is, the key sentences, are important in order to answer a reading question. A feedback generation unit 200 generates personalized feedback for an incorrect answer of a student with respect to a question based on the extracted learning material information.

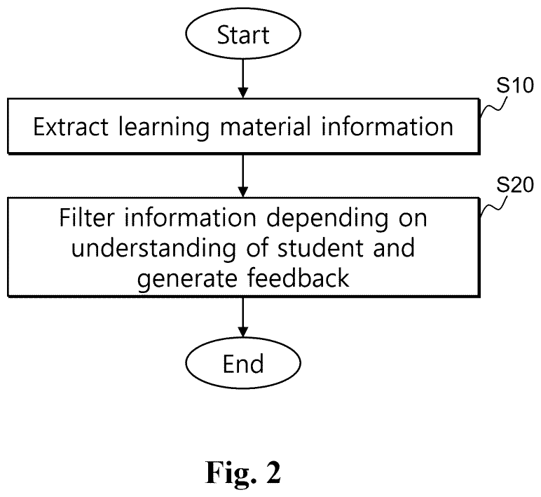

FIG. 2 is a flowchart illustrating an operation of generating personalized feedback according to an embodiment of the present disclosure. First, a learning material, for example, information necessary for a read passage is extracted (step S10). It is rare that the entire text is required in order to answer a reading question. Instead, a specific portion, that is, key sentences, are important. Feedback may be provided in a form in which such sentences are summarized, reconstructed, or abstracted. The key sentences may be an important information source in generating feedback, and thus such information is extracted from a learning material.

Next, current understanding of a student is identified based on the received learning material, a question to contents, and an incorrect answer of the student. Information extracted based on the current understanding of the student is filtered. Personalized feedback is generated based on the information (step S20).

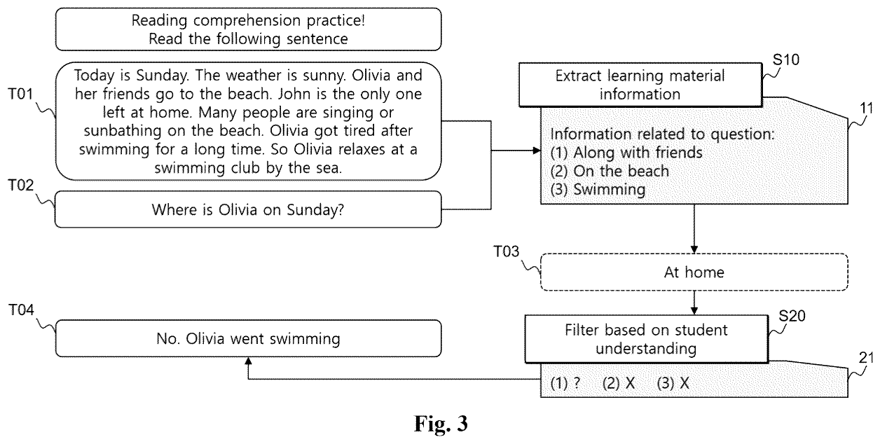

Such a process is described in detail with reference to FIG. 3. In the example of FIG. 3, when a given learning material T01, a teacher question T02 to the contents, and an incorrect answer T03 of a student are given, an automated education system according to an embodiment of the present disclosure generates personalized feedback T04. Detailed feedback, that is, a description and a hint are preferred over another feedback type as the personalized feedback T04. In the example of FIG. 3, a reading education situation is assumed. However, the example of FIG. 3 may be applied to a generalized education situation by replacing reading writing with a related field learning material.

In the example of FIG. 3, the learning material information extraction unit 100 extracts useful information 11 on question solving based on the received learning material T01 and the teacher question T02 (step S10). When the useful information 11 is extracted, an incorrect answer of the student may be used as an input or may not be used as an input. In the example of FIG. 3, information, such as “(1) Along with friends, (2) On the beach, and (3) Swimming”, is extracted as key information related to the question. Next, the feedback generation unit 200 identifies current understanding of the student based on the received learning material T01, the teacher question T02, and the incorrect answer T03 of the student, filters key information based on the current understanding of the student, and generates the personalized feedback T04 based on filtered information 21 (step S20).

In the example of FIG. 3, when the incorrect answer T03 “At home” and the extracted learning material information 11 are compared, in the incorrect answer T03, the information (2) and (3), among the extracted key information, has been missed or has not been incorporated. The information (1) is not revealed in the incorrect answer T03. Among the pierces of wrong information, the information “(2) On the beach” is not included in the personalized feedback T04 because the information (2) is directly related to the teacher question T02. The personalized feedback T04 is generated based on the information (3) that is related to the question T02, but is not directly related to the teacher question T02.

The apparatus for generating student-tailored education feedback according to an embodiment of the present disclosure may be constructed in the form of one deep learning-based end type dialogue model. Learning objectives that are specialized in improving the ability to extract information useful in question solving based on the received learning material T01 and the teacher question T02 and the ability to identify current understanding of the student based on the received learning material T01, the teacher question T02, and the incorrect answer T03 of the student and to filter the above information based on the current understanding of the student is separated into two learning steps and applied to a model.

Two model inputs generated from one data set are used to train the apparatus for generating student-tailored education feedback according to an embodiment of the present disclosure. Each of the two model inputs is assigned an input type prefix of an input sentence. That is, a knowledge source is assigned “context:” or “paragraph:”, a question is assigned “question:”, and all types of answers are assigned “answer:”. Furthermore, a rule for dialogue modeling is observed, and a knowledge source is prioritized. A first model input x_{wo_key} (common input) includes “paragraph:P question:Q answer:A^{S}”. An expected model output y is corresponding feedback F. A second model input x_{w_key} (extension input) is extended from the first model input, and is generated in the form of “paragraph: P, key sentence: K, question: Q, answer: A^{S}”.

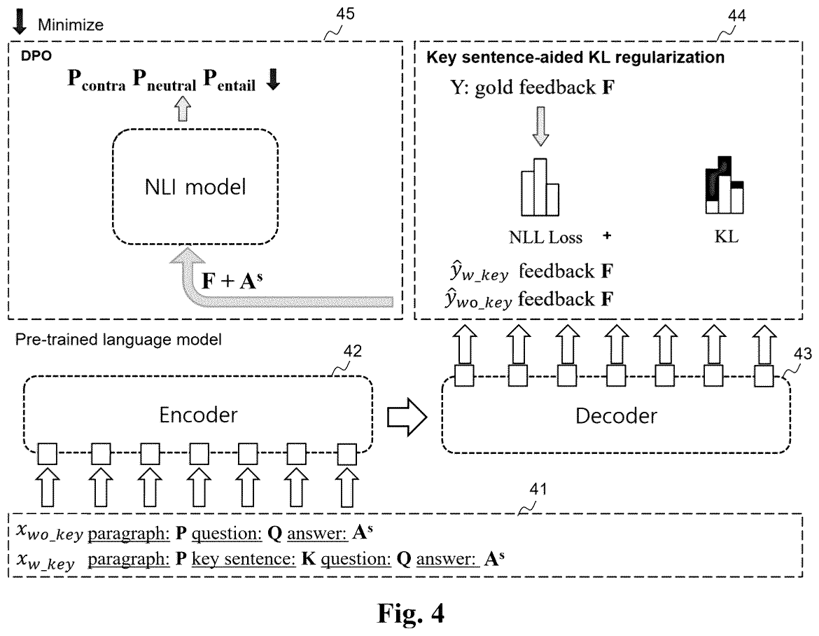

As illustrated in FIG. 4, tokenized learning input data 41 including the first model input and the second model input are input to an encoder 42, which vectorizes a corresponding token. A decoder 43 generates a new token based on the vector. The tokenized information is used to perform training for improving the ability to extract information useful in question solving and the ability to identify current understanding of a student and to filter information accordingly through a key sentence-aided Kullback-Leibler (KL) regularization step 44 and a direct preference optimization (DPPO) step 45.

### 1. Key Sentence-Aided KL Regularization

A case in which the entire text is required in order to answer a reading question is rare. Instead, a specific portion, that is, key sentences are important. Feedback may be provided in a form in which such a sentence is summarized, reconstructed, or abstracted, which may become an important information source in generating feedback. Key sentence information may be included in a learning data set, but is rarely included in an actual situation. Accordingly, when the model is trained, the model is trained to independently identify an important portion upon inference by using key sentence information as an anchor.

Such a process is illustrated in 45 of FIG. 4. Both a basic input and an extension input are transmitted to the model. Negative log-likelihood (NLL) losses

$${L}_{NLL}^{wo\_key} and {L}_{NLL}^{w\_key}$$

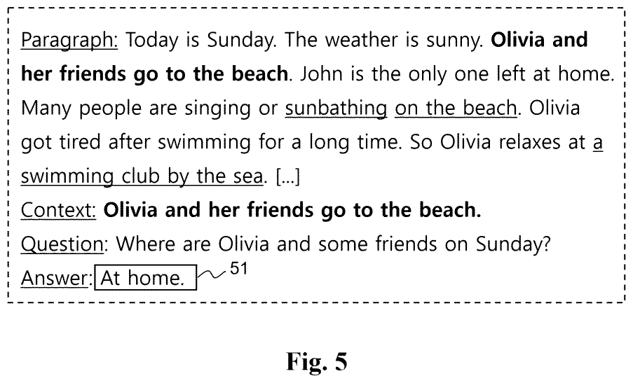

by a person, are calculated. In the case of the extension input, the model will start to concentrate its attention on explicit key sentences. If key sentences are not explicitly designated, it is ideal for the model to find a portion having a similar meaning in a given passage. FIG. 5 illustrates sentences having meanings, which come from the incorrect answer 51 of the student and are related to key sentences in the example of FIG. 3. In the example of FIG. 5, bold letters indicate the key sentence, and an underlined portion indicates sentences having related meanings.

In an embodiment of the present disclosure, in order to encourage such an array, a Kullback-Leibler (KL) regularization term, that is, a criterion indicating how different a model probability distribution is from an actual probability distribution, is added on an output distribution. Accordingly, a distribution ŷ_{w_key} generated by an input including key sentences is interpreted as a constant. An output distribution ŷ_{wo_key} generated by an input not including key sentences is forced to mimic the distribution ŷ_{w_key}.

In this manner, the NLL learning objective function is calculated, and the model is trained by the extension input including the key sentences in addition to the common input. In the case of the extension input, the model will soon start to concentrate his attention on the key sentences and may generate better feedback more smoothly. A key sentence is a part of writing, and has only to be found although the key sentence is not separately provided. In order to accelerate this, a KL regularization term between two output distributions is calculated and used as an additional objective function. In this case, the output distribution of the input including the key sentences is assumed to be an objective distribution and blocks a flow of a gradient. In contrast, the KL regularization term is minimized through a flow of a gradient of the output distribution of the common input. That is, a learning objective function, such as Equation 1, is used.

$${L}_{NLL}^{total} = 0.5 \times {L}_{NLL}^{wo\_key} + 0.5 \times {L}_{NLL}^{w\_key} + KL ( {\hat{y}}_{wo\_key} ‖ {\hat{y}}_{w\_key} ) \qquad ( 1 )$$

### 2. Direct Preference Optimization (DPO)

If good feedback can be provided regardless of an answer of a student, a complicated generation model will not be required. Pre-defined feedback stored in a database has only to be used along with each problem. How such an approach method fails is described below. When reading the passage of FIG. 2 that describes a group of friends who go to the beach and sunbath again, if a student has missed or erroneously understood a portion in which the beach was mentioned, the student may erroneously infer a corresponding location. However, the student may memorize that the swimming friends were mentioned in the passage and may erroneously think that they went to the swimming pool. In this case, providing feedback such as “No, they went swimming” supports the student's interpretation but provides no basis for why it should be questioned, which may cause the student frustration and confusion. Such feedback is not appropriate in given context, but may be perfectly appropriate when an answer of another student is considered. For example, if the student has answered that the friends spent time “at home!”, informing the student that the friends actually went swimming may provide new knowledge that does not align with the understanding of the student for current text.

As illustrated, the same feedback and information included in the same feedback may be good or bad depending on context, that is, an incorrect answer of the student. When the student missed the portion in which the beach was mentioned or answered that the friends stayed at home without interpretation due to a lack of vocabulary, if the student is given with a hint that the friends actually went swimming, new information that is not matched with the current understanding of the student is provided to the student. However, if the student memorizes the contents that the friends went swimming and gives an incorrect answer that the friends went to a swimming pool through inference, the same feedback no longer provides any benefit.

In order to determine whether feedback is bad feedback or good feedback depending on context, a natural language inference (NLI) model may be used as illustrated in 45 of FIG. 4. The NLI model predicts whether inputs have an entailment relation or a contradiction relation by receiving a premise including several sentences and hypothesis including several sentences as the inputs. This is a classification problem, but classification models assign a probability to a model class in order to determine a class and extract a class having the highest probability. In contrast, an entailment probability refers to a probability that is assigned to an entailment class regardless of a class having the highest probability. To this end, the entailment relation is calculated by using an answer of the student as a premise and a feedback option as hypothesis. Good feedback must include information that is not included in the answer of the student. As a result, the entailment probability Pₑₙₜₐᵢₗ is reduced.

In the question related to the passage of FIG. 2, if the answer of the student is “Olivia is at home”, the feedback “No. Olivia went swimming” is good feedback because the feedback includes information not included in the answer of the student (a low entailment probability), and the feedback “No. Olivia played with friends” is bad feedback.

On the premise of an incorrect answer of the student, feedback should not be the entailment relation. The reason for this is that knowledge that falls outside understanding of the student cannot be entailed. Feedback that is constructed by selecting erroneous information from the answer of the student or erroneous feedback, such as copying a premise portion without any change, may cause a higher entailment score. In an embodiment of the present disclosure, the model is guided to generate such bad feedback less frequently.

To this end, the model that is trained through a previous step with respect to inputs including separately isolated learning data generates N feedback candidates. The N feedback strategy is used for the diversity of feedback, and may be produced through a sampling scheme, such as top-K, top-P (nucleus sampling), or temperature sampling. The entailment probability of the NLI model is calculated for each candidate. A candidate having the highest probability is assumed to be bad feedback, a candidate having the lowest probability is assumed to be good feedback, and the remainder is discarded.

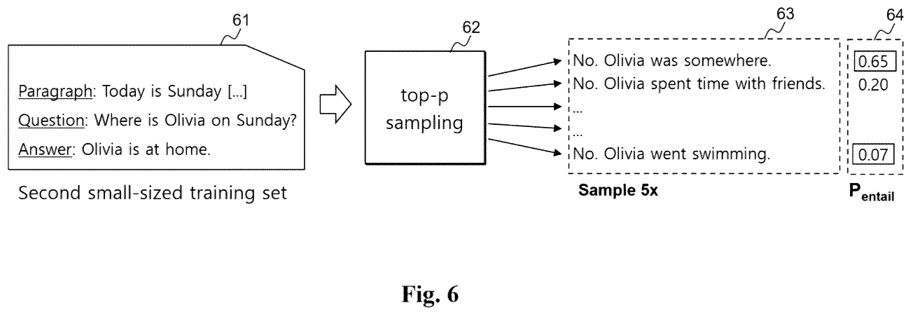

This is described in detail with reference to FIG. 6. In an embodiment of the present disclosure, direct preference optimization (DPO) using a loss is adopted. In the case of DPO, a preference learning step is performed right after an initial step for fine adjustment, which is monitored without constructing or referring to an external compensation model. When an input to a fine-adjusted model and a pair of a preferred response and a non-preferred response are given, DPO increases the relative log probability of the preferred response to the non-preferred response. In order to construct such a pair, the fine-adjusted model, that is, the results of the previous section 44, is applied to a second small-sized training set 61 that has been divided. 5 generations are sampled by using top-p sampling in which p is 1.0 with respect to each item (62). A degree of entailment for each of the sampled generations 63 is calculated (64). Feedback having the lowest degree of entailment and feedback having the highest degree of entailment become a preferred response and a non-preferred response, respectively. In the example of FIG. 6, “No, Olivia was somewhere” becomes a non-preferred response because the degree of entailment is the highest of 0.65, and “No, Olivia went swimming” becomes a preferred response because the degree of entailment is the lowest of 0.07. The remaining generations are discarded.

In order not to lose advantages of key sentence-aided KL regularization, the process may be repeated twice. That is, the process is performed once

$$( {L}_{DPO}^{w\_key} )$$

only when an input includes key sentences and is performed once

$$( {L}_{DPO}^{w\_key} )$$

only when an input does not include key sentences. In an embodiment, when an entailment probability difference between a preferred response and a non-preferred response for an input not including key sentences is smaller than 0.1, all items may be deleted.

A pair of

$${L}_{DPO}^{w\_key} and {L}_{DPO}^{w\_key}$$

obtained in this manner may be used to calculate a DPO learning objective function. As an alternative, there is a method of directly using the entailment probability for another reinforced learning method, such as PPO. An objective function, such as Equation 2, is used as a loss for preference optimization.

$${L}_{DPO}^{total} = 0.5 \times {L}_{DPO}^{wo\_key} + 0.5 \times {L}_{DPO}^{w\_key} + KL ( {\hat{y}}_{wo\_key} ‖ {\hat{y}}_{w\_key} ) \qquad ( 2 )$$

In an embodiment of the present disclosure, the KL regularization method has been used in the method of extracting information that is useful for question solving in a given knowledge material. The NLI model has been used as a method of filtering information useful for question solving depending on current understanding of a student, which is expressed as an incorrect answer of the student. The DPO-based preference optimization reinforced learning method using inference results has been used. However, the methods are merely examples for clearly describing detailed implementation methods according to embodiments of the present disclosure. In actual implementations, another related algorithm may be used for each part. For example, if the entailment probability is handled as a reward, proximal policy optimization (PPO), generalized preference optimization (GPO), and Kahneman-Tversky optimization (KTO) may also be used.

The method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

Although the present disclosure has been described with reference to the preferred embodiments, those skilled in the art may understand that the present disclosure may be modified and changed in various ways without departing from the spirit and scope of the present disclosure written in the claims.

### DESCRIPTION OF REFERENCE NUMERALS

41: learning input data, 42: encoder, 43: decoder, 44: key sentence-aided KL regularization step, 45: DPO step, 100: learning material information extraction unit, 200: feedback generation unit.

What is claimed is:

1. A method of generating student-tailored education feedback, the method comprising:
an information extraction step of extracting required learning material information from a learning material; and
a feedback generation step of generating personalized feedback based on the extracted learning material information, a question to contents of the learning material, and an incorrect answer of a student.

2. The method of claim 1, wherein the learning material information comprises one or more key sentences of the learning material.

3. The method of claim 2, wherein the information extraction step is performed by using a dialogue model that is trained by using a first model input comprising paragraphs, questions, and answers and a second model input that is extended from the first model input and that comprises paragraphs, key sentences, questions, and answers.

4. The method of claim 3, wherein the dialogue model is trained by using a negative log-likelihood (NLL) loss of the first model input and the second model input as a first loss function.

5. The method of claim 4, wherein the first loss function further comprises a Kullback-Leibler (KL) regularization term between a distribution generated by the first model input and an output distribution generated by the second model input.

6. The method of claim 5, wherein the feedback generation step comprises:
filtering information based on the question and the incorrect answer among pieces of key information extracted in the information extraction step, and
generating the personalized feedback based on the filtered information.

7. The method of claim 6, wherein the feedback generation step is performed by using the dialogue model trained by using a second loss function that is generated by generating a plurality of feedback candidates, calculating an entailment probability of each of the feedback candidates, selecting feedback having a highest entailment probability and feedback having a lowest entailment probability, among the plurality of feedback candidates, as a preferred response and a non-preferred response, respectively, and increasing a relative log probability of the preferred response to the non-preferred response by using direct preference optimization (DPO).

8. The method of claim 7, wherein the plurality of feedback candidates is generated by using a top-K sampling scheme.

9. The method of claim 7, wherein the second loss function comprises a loss function generated by using the first model input and a loss function generated by using the second model input.

10. The method of claim 9, wherein the second loss function further comprises a KL regularization term between the distribution generated by the first model input and the output distribution generated by the second model input.

11. An information extraction method of generating student-tailored education feedback, the information extraction method comprising:
extracting required learning material information from a learning material by using a dialogue model that is trained by using a first model input comprising paragraphs, questions, and answers and a second model input that is extended from the first model input and that comprises paragraphs, key sentences, questions, and answers.

12. The information extraction method of claim 11, wherein the learning material information comprises one or more key sentences of the learning material.

13. The information extraction method of claim 12, wherein the dialogue model is trained by using a negative log-likelihood (NLL) loss of the first model input and the second model input as a first loss function.

14. The information extraction method of claim 13, wherein the first loss function further comprises a Kullback-Leibler (KL) regularization term between a distribution generated by the first model input and an output distribution generated by the second model input.

15. The information extraction method of claim 14, further comprising tokenizing the first model input and the second model input by using an encoder-decoder pair.

16. A method of generating student-tailored education feedback, which generates personalized feedback based on learning material information, a question to contents of the learning material, and an incorrect answer of a student, wherein the method is performed by using a dialogue model trained by using a second loss function that is generated by generating a plurality of feedback candidates, calculating an entailment probability of each of the feedback candidates, selecting feedback having a highest entailment probability and feedback having a lowest entailment probability, among the plurality of feedback candidates, as a preferred response and a non-preferred response, respectively, and increasing a relative log probability of the preferred response to the non-preferred response by using direct preference optimization (DPO).

17. The method of claim 16, wherein the plurality of feedback candidates is generated by using a top-K sampling scheme.

18. The method of claim 16, wherein the second loss function comprises a loss function generated by using the first model input and a loss function generated by using the second model input.

19. The method of claim 18, wherein the second loss function further comprises a KL regularization term between the distribution generated by the first model input and the output distribution generated by the second model input.

20. The method of claim 19, further comprising tokenizing the first model input and the second model input by using an encoder-decoder pair.
